(19) United States
(12) Patent Application Publication
(10) Pub. No.: US 2006/0131856 A1
(43) Pub. Date: Jun. 22, 2006

(54) Gas bag module with a discharge opening

(75) Inventors: Helga Heist, Laufach (DE); Martin Kreuzer, Kleinwallstadt (DE); Markus Keutz, Rossdorf (DE); Michael Lehmann, Aschaffenburg (DE); Joachim Fellhauer, Nilkheim (DE); Lutz Haese, Aschaffenburg (DE); Michael Schneider, Sulzbach (DE); Michael Deckenhoff, Duelmen (DE); Matthias Helmstetter, Aschaffenburg (DE); Klaus Freudenberger, Aschaffenburg (DE); Thomas Britz, Bessenbach (DE); Marcus Magoley, Aschaffenburg (DE)

Correspondence Address: TAROLLI, SUNDHEIM, COVELL, & TUMMINO L.L.P., 1111 LEADER BLDG., 526 SUPERIOR AVENUE, CLEVELAND, OH, 44114-1400, US

(73) Assignee: TRW Automotive Safety Systems GmbH

(21) Appl. No.: 11/301,953

(22) Filed: Dec. 13, 2005

(30) Foreign Application Priority Data
Dec. 16, 2004 (DE) 20 2004 019 445.7

(51) Int. Cl. B60R 21/26; B60R 21/239

(52) U.S. Cl. 280/740; 280/742; 280/743.1

(57) ABSTRACT

A gas bag module for a vehicle occupant restraint device includes a rigid component (10). The rigid component (10) has a discharge opening (12) formed therein through which gas can escape. The discharge opening (12) is covered by a flat covering part (14). The flat covering part (14) includes an extensible material and has at least one hole (16).

### TECHNICAL FIELD

The invention relates to a gas bag module for a vehicle occupant restraint device, in particular to a module with a discharge opening through which gas can escape.

### BACKGROUND OF THE INVENTION

Basically, in a gas bag module, the gas bag is to be filled as quickly as possible with the gas generated by the gas generator. In particular cases it is, of course, desirable, to adapt the quantity of gas or the internal pressure in the gas bag to particular conditions. For this purpose, discharge openings which are able to be freed can be provided in the gas bag itself or in rigid components of the gas bag module.

From US 2004/0 051 285 A1 a gas bag module is known with valve flaps which can close or free discharge openings formed in a gas generator carrier. The valve flaps are connected by limiting straps to a part of the gas bag fabric facing the vehicle occupant. On activation of the gas bag module, the valve flaps are initially in the open position, so that gas can escape. If the unfolding gas bag comes in contact very early with the vehicle occupant, the discharge openings remain open. Thereby, the pressure of the unfolding gas bag and hence the force exerted onto the vehicle occupant is reduced. If, on the other hand, the vehicle occupant is in a position which is further away from the gas bag module, the discharge openings are closed in the course of further unfolding by means of the limiting straps, against the internal pressure of the gas bag, so that no more gas can flow off. US 2004/0 051 285 A1 also mentions another design, according to which the valve flaps are initially closed and only open with increasing internal pressure of the gas bag.

It is an object of the invention to provide a gas bag module with a discharge opening, the effective cross-section of which regulates itself by simple means.

### BRIEF SUMMARY OF THE INVENTION

The gas bag module for a vehicle occupant restraint device according to the invention includes a rigid component. The rigid component has a discharge opening formed therein. Through the discharge opening gas can flow off. The discharge opening is covered by a flat covering part. The flat covering part includes an extensible material and has at least one hole.

The covering part provided according to the invention makes possible in a simple manner an automatic adaptation of the outflowing quantity of gas as a function of the internal pressure prevailing in the gas bag. The covering part is extended more intensively with increasing internal pressure of the gas bag, whereby automatically the cross-section of the hole becomes larger. Thereby, at higher pressure, more gas flows through the hole, so that as a whole more gas can escape through the discharge opening.

In order to ensure that the discharge opening is initially at least partially covered and to thereby largely prevent an initial emergence of gas, the hole is to have a smaller cross-section than the discharge opening.

The enlargement of the effective discharge cross-section through the expansion of the hole in the covering part is particularly efficient when the hole is arranged substantially concentrically over the discharge opening.

To avoid additional leakage flows through the discharge opening, it is advantageous to fasten the covering part substantially in a gas-tight manner on the edge of the discharge opening.

The covering part can, in particular, comprise a fabric piece or a foil.

### BRIEF DESCRIPTION OF THE DRAWINGS

FIG. 1 shows a cut-out of a gas bag module according to the invention with a discharge opening; and

FIG. 2 shows the cut-out of the gas bag module of FIG. 1 with a high application of pressure.

### DETAILED DESCRIPTION OF THE PREFERRED EMBODIMENT

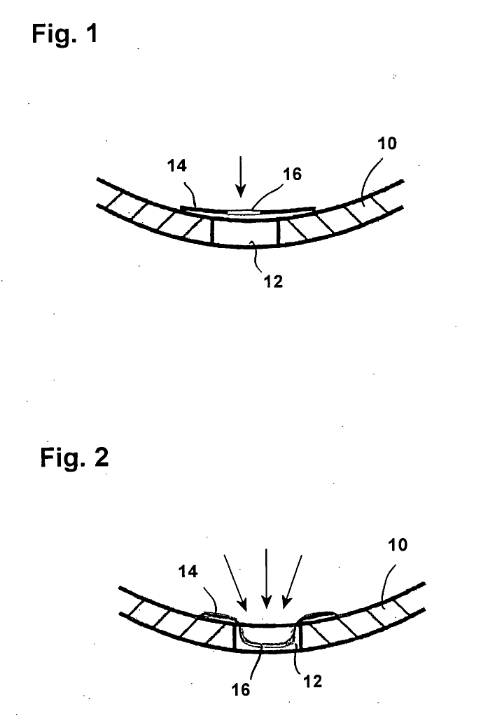

In FIG. 1 a rigid component 10 of a gas bag module is illustrated, which may for example be a gas generator carrier or a wall of a module housing. In the rigid component 10 a discharge opening 12 is formed, through which a portion of the gas, which is generated for filling the gas bag of the module, can escape.

On the inner side of the rigid component 10, a flat covering part 14 is stretched over the discharge opening 12, the outer edge of the covering part 14 around the discharge opening 12 being fastened in a substantially gas-tight manner on the rigid component 10. The covering part 14 consists of an extensible material and can, for example, be a fabric piece or a foil. In the center of the covering part 14, a hole 16 is provided which is arranged substantially concentrically over the discharge opening 12. In the normal state, which is shown in FIG. 1, the hole 16 has a distinctly smaller cross-section than the discharge opening 12.

If, with the filling of the gas bag, only a low pressure acts on the covering part 14, the latter substantially retains its shape and only a little gas can emerge through the hole 16 and subsequently through the discharge opening 12.

FIG. 2 shows a state in which a high internal pressure of the gas bag prevails and the covering part 14 is accordingly acted upon with a high pressure. The covering part 14 is pressed onto the edge of the discharge opening 12 and is expanded into the discharge opening 12. Owing to the expansion, the hole 12 in the covering part 14 increases in size, so that a greater quantity of gas can escape through the discharge opening 12.

With the extensible covering part 14 it is thereby achieved that the effective cross-section of the discharge opening 12 automatically adjusts itself as a function of the internal pressure of the gas bag.

1. A gas bag module for a vehicle occupant restraint device, the gas bag module including a rigid component having a discharge opening formed therein through which gas can escape, the discharge opening being covered by a flat covering part which comprises an extensible material and has at least one hole formed in the flexible material.

2. The gas bag module according to claim 1, wherein the hole has a smaller cross-section than the discharge opening.

3. The gas bag module according to claim 1, wherein the hole is arranged substantially concentrically over the discharge opening.

4. The gas bag module according to claim 1, wherein the covering part is fastened in a substantially gas-tight manner on the edge of the discharge opening.

5. The gas bag module according to claim 1, wherein the covering part comprises a fabric piece.

6. The gas bag module according to claims 1, wherein the covering part comprises a foil.
